(19) United States
(12) Patent Application Publication
(10) Pub. No.: US 2007/0125915 A1
(43) Pub. Date: Jun. 7, 2007

(54) Multiple telescoping tube comprising a load-controlled locking device

(76) Inventor: Dieter Hein, Windach (DE)

Correspondence Address: DILWORTH & BARRESE, LLP, 333 EARLE OVINGTON BLVD., SUITE 702, UNIONDALE, NY, 11553, US

(21) Appl. No.: 10/529,443

(22) PCT Filed: Sep. 15, 2003
(86) PCT No.: PCT/EP03/10243

§ 371 Date: Dec. 21, 2005

(30) Foreign Application Priority Data
Sep. 26, 2002 (DE) 102 44 994.5

(51) Int. Cl. F16M 11/00

(52) U.S. Cl. 248/161

(57) ABSTRACT

Disclosed is a multiple telescopic tube comprising at least two parallel outer tubes (1), at least two inner tubes (2) which are disposed parallel to the outer tubes (1) and are movable relative to said outer tubes (1) in a longitudinal direction (Z), and a clamping device (3) which is provided with a clamping engagement element (5) that can be made to engage with the exterior surfaces of the inner tubes (2). The clamping device (3) prevents displacement of the inner tubes (2) relative to the outer tubes (1) in a longitudinal clamping direction while the inner tubes (2) remain movable in the opposite longitudinal direction when the multiple telescopic tube is subjected to a load in said longitudinal clamping direction. The inventive multiple telescopic tube can be used as a leg of a camera stand, for example.

### TECHNICAL FIELD

The present invention relates to a multiple telescopic tube. The term “multiple” implies that at least two outer tubes arranged parallel to each other and at least two inner tubes arranged parallel to the outer tubes are provided, the inner tubes being displaceable relative to the outer tubes in the longitudinal direction, and specifically steplessly displaceable. The term also implies, however, that at least two tubes are provided and are displaceable into each other, in the telescoping direction. A clamping device serves to lock the inner tubes relative to the outer tubes in any desired relative position.

Multiple telescopic tubes of this type are usable particularly as legs for camera stands. For instance, in the case of a tripod camera stand, three such multiple telescopic tubes are provided, each forming a stand leg.

The term “telescopic tube” implies in the following that the inner tubes are displaceable parallel to the outer tubes in order to elongate or shorten the multiple telescopic tube—in particular the stand leg. However, in this context, the inner tubes are not necessarily slideably arranged in the outer tubes, but may also be provided beside them.

### PRIOR ART

A camera stand with three double telescopic tubes, each forming a stand leg, is known, for instance, from WO 93/12372. Here, the inner tubes may be slideably arranged in or beside the outer tubes. Locking of the inner tubes relative to the outer tubes takes place, in each case, by means of a clamping device which is actuatable, for instance, with a grip screw or a locking lever. The clamping device must be loosened in order to be able to extend or collapse the stand leg and after the extension or collapsing, it must be tightened again.

In this conventional stand, each stand leg has two telescopic units or sections, i.e. a total of six clamping devices are provided. If, for instance, all three stand legs are to be extended fully from the collapsed condition, six screws must therefore be loosened and tightened again. This is laborious, particularly in the case of rapid and frequent changes of camera set-up.

In the German patent specification No. 846 040, a locking device for tubes of telescopic design as found, for instance, in mechanical grippers is described. The telescopic design consists here only of a single outer tube and an inner tube arranged slideably therein, so that this is a single telescopic tube. For locking the inner tube in relation to the outer tube, a clamping device in the form of a wedge construction is provided in the interior of the two tubes, such that the clamping is effected within the telescopic tube. If a compression load acts upon the telescopic tube, the clamping device prevents the collapsing of the telescopic tube, whilst the telescopic tube remains able to extend further at any time. The greater the compression load, the stronger the clamping force becomes. With the reverse arrangement of the wedge design, extension of the telescopic tube may be prevented, whilst the telescopic tube is able to be collapsed further at any time. A release device is also provided in order to release the locking again whenever desired.

### SUMMARY OF THE INVENTION

It is the problem (object) of the invention to provide a multiple telescopic tube which, with optimal and simple fixing of the relative position of the telescopic tubes, is extensible and collapsible with the smallest possible effort, whereby the design effort should also remain as small as possible. At the same time, as large a clamping force as possible should be achievable.

This problem is solved according to the invention in conjunction with the features of claim 1 in that the multiple telescopic tube is provided with a clamping device which has a clamping engagement element. This engagement element may be brought into engagement with the outer surfaces of the inner tubes. On loading of the multiple telescopic tube in a longitudinal clamping direction, and thereby actuating clamping, the clamping device prevents displacement of the inner tubes relative to the outer tubes in this longitudinal clamping direction, whilst the displaceability in the opposing longitudinal direction is maintained.

The loading in the longitudinal clamping direction of the multiple telescopic tube may be either compression loading of the telescopic tube and/or tensional loading of the telescopic tube.

In the former case, the multiple telescopic tube with the clamping device according to the invention may therefore always be extended without any type of device having to be actuated, in particular without a screw or a locking lever having to be loosened. The locking of the multiple telescopic tube in the desired length is then simply thereby achieved that a compression loading is applied to the multiple telescopic tube. In the case of the use of the multiple telescopic tube as a camera stand leg, this compression loading may be brought about, for instance, by the weight of a camera situated on the stand.

For locking, the clamping engagement element of the clamping device comes into engagement with the exterior surfaces of the inner tubes. Since this engagement takes place from outside the tubes, the engagement element thus being arranged between the tubes, a single clamping device is sufficient in order to perform the locking of all the available tubes of the multiple telescopic tube. This implies a relatively small design effort.

The greater the compression load tending to collapse the multiple telescopic tube, the greater the clamping force becomes, since the engagement between the clamping engagement element and the exterior surfaces of the inner tubes is further increased with increasing compression loading.

In contrast to known telescopic tubes, in which a screw must be loosened on each telescopic unit in order to be able to pull out the stand legs, the extension of the multiple telescopic tube according to the invention is much simpler without any impairment of the clamping force having to be accepted. This is advantageous particularly on use of the multiple telescopic tube as a camera stand leg if the stand must often be adjusted during quick, frequent changes of camera set-up and a large clamping force nevertheless cannot be dispensed with.

In the second case, that is when the loading in the longitudinal clamping direction of the multiple telescopic tube is a tensional load of the telescopic tube, locking of the telescopic tube against forces tending to pull the telescopic tube apart is achieved. The telescopic tube may be pushed together again at any time. This may be desirable if, for instance, a heavy object, for instance a studio lamp is hung on the telescopic tube. In this case, also, the clamping force increases with increasing load, in this case with increasing tensional load.

In both cases, the telescopic tube may be displaced in one direction at any time without actuating any type of device, whilst displacement in the opposing direction is always reliably prevented by load-controlled locking.

Further advantageous embodiments of the multiple telescopic tube according to the invention are disclosed in the dependent claims.

As mentioned above, at least one of the inner tubes may be arranged in one of the outer tubes. This enables a particularly space-saving design of the multiple telescopic tube.

In a preferred embodiment of the invention, the clamping device also has an engagement actuation element triggering actuation of the clamping engagement element, said engagement actuation element being firmly linked to the outer tubes and movable relative to the clamping engagement element. The term “engagement actuation element” includes the concept that the actuation takes place in that the clamping engagement element is moved relative to the engagement actuation element in order to bring about the clamping engagement actuation. On loading of the multiple telescopic tube in the longitudinal clamping direction, i.e. compression or tensional loading, the engagement actuation element comes into engagement with the clamping engagement element and brings about the locking. The relative movement between the engagement elements preferably brings about a movement of the clamping engagement element in the direction of the exterior surfaces of the inner tubes, preferably approximately perpendicular to the telescopic movement.

Preferably, the clamping device also has a release device for releasing the engagement between the clamping engagement element and the exterior surfaces of the inner tubes. This release device may be, for instance, a slider movable in the longitudinal direction of the multiple telescopic tube, said slider being particularly simple to actuate; other embodiments are, however, also conceivable. By means of the release device, the clamping engagement element is preferably movable relative to the engagement actuation element, such that the engagement between the two engagement elements and thus also the engagement between the clamping engagement element and the inner tubes may be released by means of the release device.

Preferably, the release device is pretensioned, by means of an elastic element, in a direction opposed to the release. The release device is then actuated against this pretension in order to release the clamping.

The engagement actuation element preferably interacts directly with the clamping engagement element and, for this purpose, is designed to be complementary to the clamping engagement element. For instance, the engagement actuation element may be designed as a wedge whose inclined surfaces interact with inclined surfaces of the clamping engagement element, such that the relative movement of the two engagement elements bring about engagement and locking of the clamping engagement element with the inner tubes.

Preferably, the clamping engagement element comprises a plurality of members, whereby in particular the number of members of the clamping engagement element may be equal to the number of inner tubes present. The individual members of the clamping engagement element are then each brought into engagement with the exterior surface of one inner tube. Each member of the clamping engagement element preferably simultaneously interacts with the engagement actuation element, i.e. the interaction of the engagement actuation element with the multiple-part clamping engagement element brings about a simultaneous clamping of all the inner tubes.

The multiple telescopic tube may, for instance, have two inner tubes and two outer tubes, whereby this is then a double telescopic tube.

The clamping device may have a housing in which the engagement elements are accommodated and which is firmly linked to the outer tubes.

Finally, a camera stand according to the invention has at least one multiple telescopic tube according to the invention as a stand leg.

The telescopic tubes may have various cross-sectional forms, such as round, oval or polygonal.

### BRIEF DESCRIPTION OF DRAWINGS

The invention will now be described in greater detail with the aid of an example embodiment as illustrated in the drawings, in which:

FIG. 1 shows a perspective view of a double telescopic tube according to the invention;

FIGS. 2a and 2b show a front view, and a longitudinal sectional view along the line A-A of FIG. 2a, of this double telescopic tube according to the invention;

FIG. 3 shows a perspective view of the double telescopic tube according to the invention, whereby a release device is not shown; and

FIGS. 4a, 4b and 4c show a front view, and a longitudinal sectional view along the line A-A of FIG. 4a, and a cross-sectional view along the line B-B of FIG. 4a, of the double telescopic tube according to the invention, whereby the release device is also not shown.

### DETAILED DESCRIPTION OF AN ADVANTAGEOUS EMBODIMENT

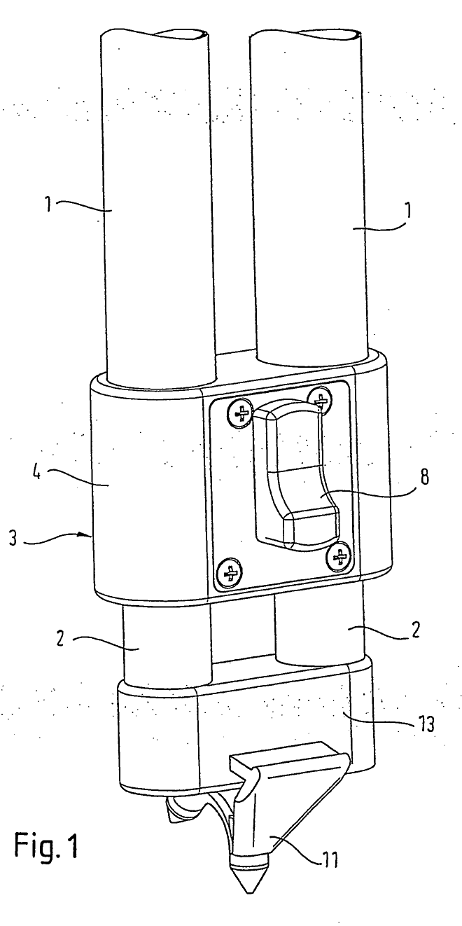

An advantageous embodiment of a multiple telescopic tube according to the invention is illustrated in FIGS. 1 to 4.

The double telescopic tube according to the embodiment illustrated here is particularly suitable for use as a stand leg of a camera stand, for instance a monopod stand or a tripod stand. It has two outer tubes 1 and two inner tubes 2. The inner tubes 2 are arranged slideably displaceable in the outer tubes 1, such that the length of the stand leg is steplessly adjustable.

The material used for the inner tubes 2 and the outer tubes 1 is preferably a light material such as carbon fibre or aluminium.

In order to fix the inner tubes 2 in relation to the outer tubes 1 and thus to adjust the stand leg at a desired length, a clamping device 3 is provided. The housing 4 of this clamping device 3 is firmly linked to the two outer tubes 1.

The two inner tubes 2 are rigidly coupled together at their lower ends via a cross-bar 13, on which is provided a double spike 11 by means of which the stand leg is placed on the ground. This is therefore the lowest section of a stand leg. The invention is also usable, however, on other sections of a stand leg of this type.

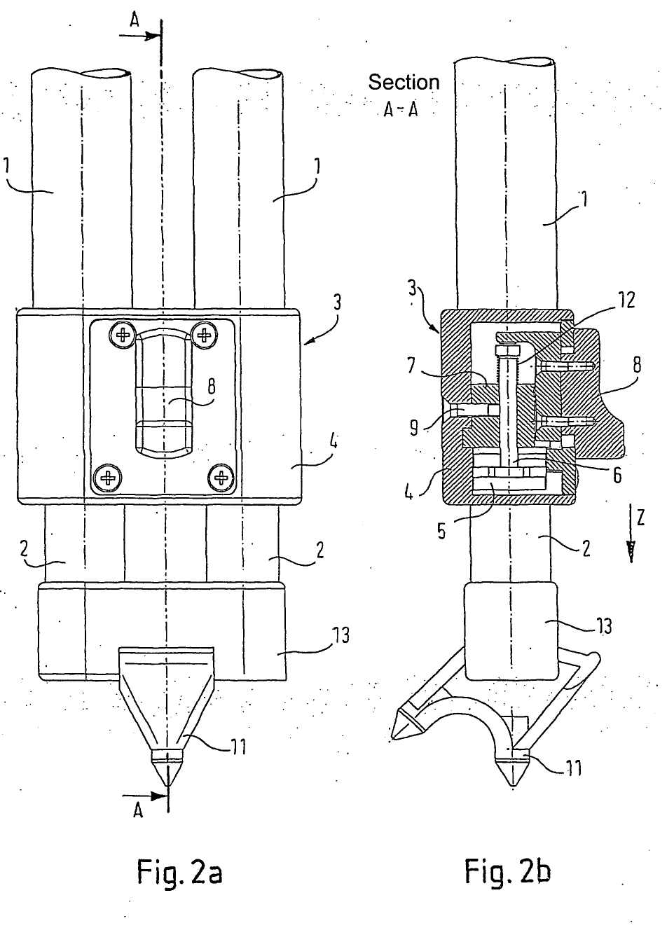

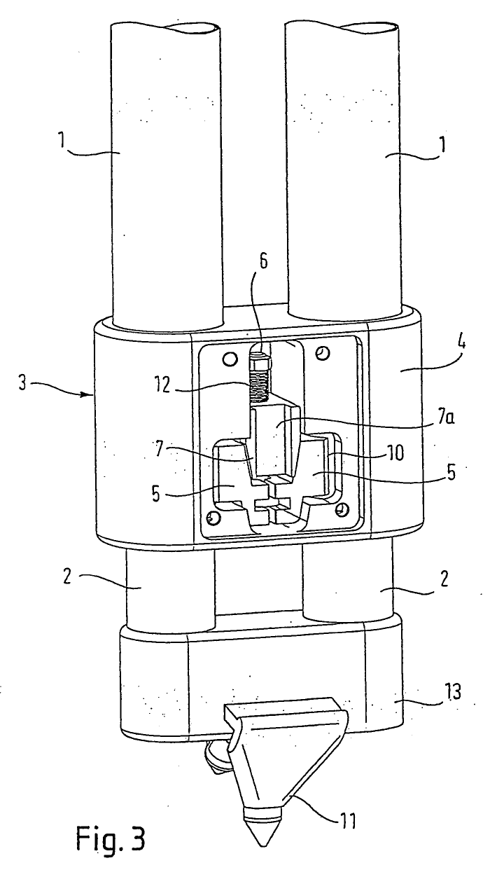

The structure of the clamping device 3 according to the invention will now be described by reference to FIGS. 2a, 3b and 3. In FIG. 3, a slider 8, whose function will be described in greater detail, is not shown, such that the inner structure of the clamping device 3 is made visible.

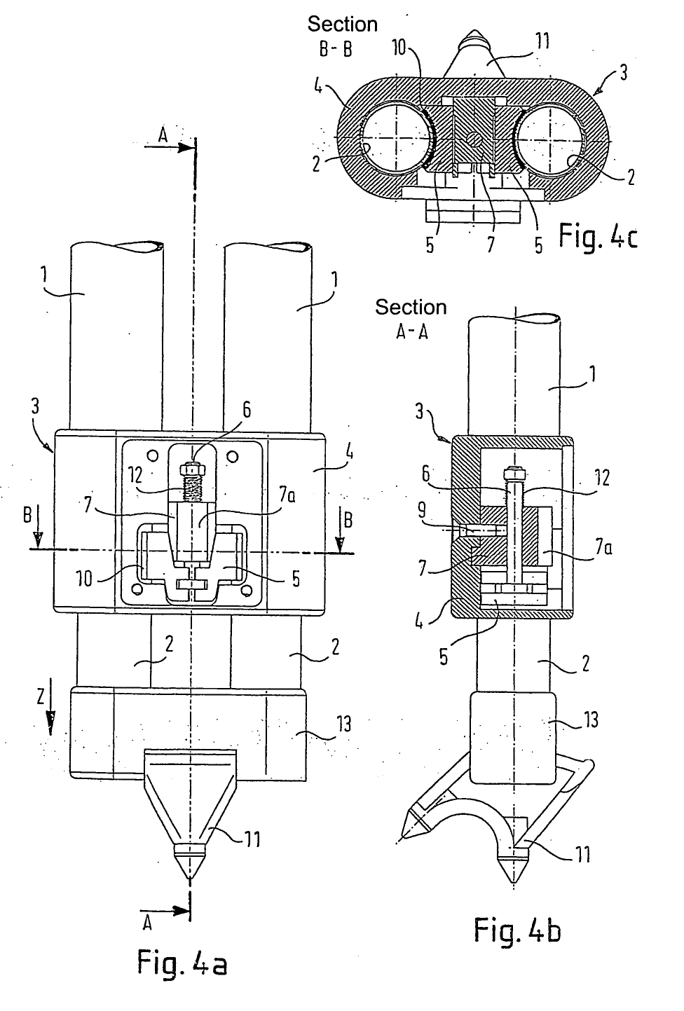

An expanding wedge 7 (the engagement actuation element) is firmly linked by means of a screw 9 to the housing 4 of the clamping device 3. A guide rod 6 extends through the expanding wedge 7, such that it is movable in the vertical direction relative to the expanding wedge 7 and thus also relative to the housing 4, i.e. in the direction designated in FIG. 2b as “Z”. The head of the guide rod 6 is in engagement with two clamping jaws 5 (two-part clamping engagement element), which are arranged on either side of the expanding wedge 7 and have inclined surfaces which interact with inclined surfaces of the expanding wedge 7. On their surfaces facing away from the expanding wedge 7, the clamping jaws 5 are provided with friction linings 10 (see FIG. 4c), by means of which they may be brought into clamping engagement with the inner tubes 2. The engagement between the head of the guide rod 6 is such that the guide rod 6 and the clamping jaws 5 may move together backwards and forwards in the Z-direction, whilst the clamping jaws 5 may move perpendicular to this towards and away from each other.

As is clear in particular from the sectional view A-A of FIG. 2b, the slider 8 is linked to the guide rod 6 such that the latter is movable downwards in the Z-direction relative to the expanding wedge 7, whereby the guide rod 6 takes the two clamping jaws 5 with it. Situated between the guide rod 6 and the expanding wedge 7 is a return spring 12, which pretensions the slider 8 and thus also the guide rod 6 and the clamping jaws 5 upwards and, in the rest position, causes a wedge effect between the expanding wedge 7 and the clamping jaws 5, by means of which the clamping jaws are pressed into clamping engagement with the inner tubes 2.

FIG. 4a shows a front view of the clamping device 3 according to the invention, whereby the slider 8 is also not shown. In the sectional view B-B of FIG. 4c, the friction linings 10 of the clamping jaws 5 and their arrangement in relation to the inner tubes 2 are particularly clearly recognisable. It is clear from the sectional view A-A according to FIG. 4b that a groove 7a which serves to accommodate and guide the slider 8 is provided in the expanding wedge 7.

The clamping device 3 according to the invention functions as follows.

The stand leg may always be extended without actuating the slider 8 or any other device; i.e. the inner tubes 2 can simply be pulled out of the outer tubes 1, since a possible frictional force between the inner tubes 2 and the clamping jaws 5 will loosen the expanding wedge 7 and the clamping jaws 5 from each other against the wedge effect. As soon as a load, for instance the weight of a camera, acts in the longitudinal direction: of the stand leg and tends to bring about collapsing of the inner tubes 2 and the outer tubes 1, the expanding wedge 7 is pushed further between the two clamping jaws 5. A starting frictional force brings about a movement of the clamping jaws 5 against the expanding wedge 7. By means of the interaction of the inclined surfaces of the expanding wedge 7 and the inclined surfaces of the clamping jaws 5, the clamping jaws 5 are moved outwards in the direction of the two inner tubes 2. This starting frictional force comes about thereby that the springs 12 hold the friction linings 10 in engagement with the inner tubes 2. A secure fixing of the inner tubes relative to the outer tubes 1 is thereby brought about.

The larger the load acting on the stand leg, the further the expanding wedge 7 is moved between the two clamping jaws 5, and the greater is the clamping force that the clamping jaws 5 exert on the inner tubes 2. However, on releasing the load, the stand leg may be extended further at any time without the slider 8 or any other device having to be actuated.

In order to be able to collapse the stand leg again, to release the fixing between the inner tubes 2 and the outer tubes 1, the slider 8 is now pushed in the Z-direction. The slider 8 takes the guide rod 6 and the clamping jaws 5 with it, such that the engagement between the clamping jaws 5 and the expanding wedge 7 is released and the clamping jaws 5 release the inner tubes 2. The inner tubes 2 are now freely displaceable in the outer tubes 1.

In order to fix the stand leg in another working position, the slider 8 is released and moves upwards by means of the pretension of the return spring 12. By applying a load which tends to collapse the stand leg—for instance, the weight of a camera—clamping of the inner tubes 2 relative to the outer tubes 1 in the new working position is brought about.

The invention is naturally not restricted to this embodiment.

In place of the double telescopic tube shown here with two parallel outer tubes and two inner tubes arranged therein, the invention may also be applied, for instance, to triple telescopic tubes with three parallel outer tubes and three inner tubes parallel thereto.

The multiple telescopic tube may in any event have any desired number of telescopic units or sections, whereby for each telescopic unit or each section, a clamping device is provided.

Finally, the multiple telescopic tube according to the invention—aside from its use as a camera stand leg—may, for instance, also be used for different types of frames, chassis for tables and chairs, lifting jacks, etc., or for suspended constructions and lamps in studios, etc.

1. A multiple telescopic tube with at least two outer tubes (1) arranged parallel to each other and at least two inner tubes (2) arranged parallel to the outer tubes (1), the inner tubes being displaceable relative to the outer tubes (1) in the longitudinal direction (Z), and
having a clamping device (3), which comprises a clamping engagement element (5) which may be brought into engagement with the outer surfaces of the inner tubes (2), whereby,
on loading of the multiple telescopic tube in a longitudinal clamping direction, the clamping device (3) prevents displacement of the inner tubes (2) relative to the outer tubes (1) in this longitudinal clamping direction, whereas
the displaceability in the opposing longitudinal direction is maintained.

2. The multiple telescopic tube according to claim 1, wherein the loading in the longitudinal clamping direction correspond to a compression loading of the multiple tube.

3. The multiple telescopic tube according to claim 1, wherein the longitudinal clamping direction corresponds to a tensional loading of the multiple telescopic tube.

4. The multiple telescopic tube according to claim 1, wherein at least one of the inner tube (2) is arranged in one of the outer tubes (1).

5. The multiple telescopic tube according to claim 1, wherein the clamping device (3) has an engagement actuation element (7), which is firmly linked to the outer tubes (2) and is movable relative to the clamping engagement element (5).

6. The multiple telescopic tube according to claim 5, wherein on loading the multiple telescopic tube in the longitudinal clamping direction, the engagement actuation element (7) comes into engagement with the clamping engagement element (5).

7. The multiple telescopic tube according to claim 5, wherein the relative movement between the engagement elements (5, 7) brings about a movement of the clamping engagement element (5) in the direction of the outer surfaces of the inner tubes (2).

8. The multiple telescopic tube according to claim 1, wherein the clamping device (3) also has a release device (8) for releasing the engagement between the clamping engagement element (5) and the exterior surfaces of the inner tubes (2).

9. The multiple telescopic tube according to claim 8, wherein the release device (8) is a slider (8) movable in the longitudinal direction of the multiple telescopic tube.

10. The multiple telescopic tube according to claim 5, wherein the clamping engagement element (5) is movable relative to the engagement actuation element (7) of the release device (8).

11. The multiple telescopic tube according to claim 8, wherein the release device (8) is pretensioned by an elastic element (12) in a direction opposed to the release.

12. The multiple telescopic tube according to claim 5, wherein the engagement actuation element (7) is designed to be complementary to the clamping engagement element (5).

13. The multiple telescopic tube according to claim 12, wherein the engagement elements (5, 7) are in wedge-formed engagement with each other.

14. The multiple telescopic tube according to claim 1, wherein the clamping engagement element (5) comprises at least two members, between which the engagement actuation element (7) is situated.

15. The multiple telescopic tube according to claim 14, wherein the number of members of the clamping engagement element (5) is equal to the number of inner tubes (2).

16. The multiple telescopic tube according to claim 1, wherein two inner tubes (2) and two outer tubes (1) are provided.

17. The multiple telescopic tube according to claim 1, wherein the clamping device (3) has a housing (4) in which the engagement elements (5, 7) are accommodated.

18. The multiple telescopic tube according to claim 17, wherein the housing (4) is firmly linked to the outer tubes (1).

19. A stand with at least one multiple telescopic tube according to claim 1 as a stand leg.

20. The stand according to claim 19, wherein it is a camera stand.
